(19) United States
(12) Patent Application Publication
(10) Pub. No.: US 2023/0213127 A1
(43) Pub. Date: Jul. 6, 2023

(54) QUICK RELEASE CLAMP ASSEMBLY

(71) Applicant: Advanced Couplings Limited, Keighley (GB)

(72) Inventors: Keith James KENDRICK, Keighly (GB); Shaun HENRY, Oakworth (GB)

(73) Assignee: Advanced Couplings Limited, Keighley (GB)

(21) Appl. No.: 18/000,588

(22) PCT Filed: Jun. 4, 2021
(86) PCT No.: PCT/EP2021/065001

§ 371 Date: Dec. 2, 2022

Related U.S. Application Data
(60) Provisional application No. 63/035,266, filed on Jun. 5, 2020.

(51) Int. Cl. F16L 37/20; F16L 23/06

(52) U.S. Cl. CPC F16L 37/20; F16L 23/06

(57) ABSTRACT

A releasable clamp which can be installed without using a wrench to tighten it on the fittings is disclosed. The lock nut and T bar embodiments enable the clamp to place a pre-set amount of clamping pressure on a pair of pipe fittings so as to minimize the gasket compression into the pipe's flow path.

### CROSS REFERENCES AND PRIORITIES

This application claims priority from U.S. Provisional Application No. 63/035,266 filed 5 Jun. 2020, the teaching of which are incorporated by reference herein in their entirety.

### BACKGROUND

Clamps that use nuts and bolts to connect the two halves of a clamp together to create pressure, i.e. clamping force and hold two fittings together are known in the art. These clamps are cumbersome to remove and re-attach.

Additionally, the clamping pressure on the fittings is determined by the torque on the nuts/bolts used to hold the clamp segments together. These nuts/bolts are often tightened after application on the fittings. Sometimes they are torqued more than they should be, which is called over-torqueing. Over-torqueing can over compress the gasket between the fittings. In the case of deformable gaskets, like polymers, too much pressure or clamping force pushes the gasket out of the seat and into the flow path of the pipe. The extended gasket collects product and leads to unsanitary conditions.

There exists, therefore, the need for a clamp which can be quickly attached and detached for quick access to pipes and tanks which is capable of applying a pre-determined amount of clamping pressure when assembled so as to avoid applying too much clamping force during installation.

### SUMMARY

This specification discloses a releasable clamp assembly. The releasable clamp assembly comprises an upper clamp ring pivotally attached to a lower clamp ring, a shaft component, and a latch.

It is further disclosed that the upper clamp ring comprises an upper clamp ring first end with an upper clamp ring clevis. The upper clamp ring clevis has an upper clamp ring first prong with an upper clamp ring first prong through-hole and an upper clamp ring second prong with an upper clamp ring second prong through-hole. The upper clamp ring second end has an upper clamp ring through-hole with the upper clamp ring first end opposite the upper clamp ring second end.

It is further disclosed that the lower clamp ring comprises a lower clamp ring first end with a lower clamp ring clevis, a lower clamp ring second end with a lower clamp ring through-hole, with the lower clamp ring first end opposite the lower clamp ring second end.

It is also disclosed that the shaft component comprises a shaft component first end, a shaft component second end opposite the shaft component first end, a pivot area with a shaft component through-hole passing through the shaft component.

It is further disclosed that the shaft component be configured to have an effective length.

It is further disclosed that the latch comprises a latch clevis having a first pivot through-hole and a second pivot through-hole with the shaft component pivotally attached to the latch at the first pivot through-hole. The first prong through-hole is pivotally attached to a first end of the second pivot through-hole and the second prong through-hole is pivotally attached a second end of the second pivot through-hole.

The specification further discloses that the upper clamp ring and the lower clamp ring may be pivotally attached with a joint.

It is further disclosed that the joint is pivotally attached to the upper clamp ring through-hole and pivotally attached to the lower clamp ring through-hole.

The specification further discloses that the shaft component is threaded and mates with a torque nut having a torque nut tip.

The specification further discloses that the torque nut may be fixed. The specification further discloses that the torque nut may fixed such that the amount of torque required to rotate the torque nut about the shaft may be greater than 0.5 Nm, greater than 1.0 Nm, greater than 2 Nm, or in the range of 2 Nm to 50 Nm. The specification further discloses ways in which to fix the torque nut. Two ways disclosed by using a lock nut or thread locker.

The specification also discloses an embodiment where the torque nut abuts a lock nut with a lock nut torque (τ₂) which is the torque of the lock nut at the torque nut and is greater than 0 Nm. The specification further discloses that the lock nut torque applied to the torque nut may be greater than 0.5 Nm, greater than 1.0 Nm, greater than 2 Nm to 5 Nm, or in the range of 2 Nm to 50 Nm.

The specification further discloses that there is a distance between the torque nut tip and the shaft component pivot hole which is also the effective distance of the shaft component. This distance is such that a torque nut torque (τ₁) which is the torque of torque nut at the lower clamp clevis when the clamp assembly is installed around a pair of fittings is greater than 0 Nm and that this torque nut torque may be in the range of 2 Nm to 50 Nm.

The specification further discloses that the shaft component effective length is created by having the shaft component second end be larger than the space between the lower clamp clevis first prong and the lower clamp clevis second prong.

The specification also discloses an embodiment wherein the larger part of the shaft component is a “T” shape.

### BRIEF DESCRIPTION OF FIGURES

FIG. 1 is a first perspective view of an embodiment of the invention.

FIG. 2 is an end view of an embodiment of the disclosed assembly.

FIG. 3 is a second perspective view of an embodiment of the invention.

FIG. 4 is an exploded view of an embodiment of the invention.

FIG. 5 is a perspective view of an embodiment of the invention in the opened position.

FIG. 6 is a side view of an embodiment of the invention in the closed position.

FIG. 7 is an exploded view of an embodiment of the invention.

FIG. 8A is an end view of an embodiment of the disclosed assembly.

FIG. 8B is a perspective view of an embodiment of the invention in the opened position.

FIG. 8C is a side view of an embodiment of the invention in the closed position.

### DETAILED DESCRIPTION

Disclosed herein is a releasable clamp for sanitary fittings. This specification describes the releasable clamp with reference to the Figures. As described herein and in the claims, the following numbers refer to the following structures as noted in the FIGURES.

100 points to the releasable clamp assembly.

200 is the upper clamp ring.

210 is the upper clamp ring first end.

220 is the upper clamp ring clevis.

230 is the first prong of the upper clamp ring clevis.

235 is the first prong through-hole of the upper clamp ring clevis.

240 is the second prong of the upper clamp ring clevis.

245 is the second prong through-hole of the upper clamp ring clevis.

250 is the upper clamp ring second end.

260 is the upper clamp ring second end through-hole.

300 is the lower clamp ring.

310 is the lower clamp ring first end.

320 is the lower clamp ring clevis.

320A is the lower clamp ring clevis first prong.

320A is the lower clamp ring clevis second prong.

350 is the lower clamp ring second end.

360 is the lower clamp ring second end through-hole.

400 is the shaft component.

410 is the shaft component first end.

420 are the external threads at the shaft component first end.

440 is the shaft component second end.

445 is the pivot area (tang) of the shaft component through which the pivot hole passes.

450 is a shaft component pivot hole running perpendicular to the shaft component.

460 is the “T” structure at the end of the shaft.

470 is the effective length of the shaft component.

500 is the latch.

510 is the latch clevis.

510A is first prong of the latch clevis.

510B is the second prong of the latch clevis.

520A is the first end of the upper pivot through-hole of the latch clevis.

520B is the second end of the upper pivot through-hole of the latch clevis.

525 is the latch clevis pin.

530A is the first end of the lower pivot through-hole of the latch clevis.

530B is the second end of the lower pivot through-hole of the latch clevis.

535A is the first pivot button.

535B is the second pivot button.

540 depicts the shaft component pivotally attached to the latch clevis at the upper pivot through-hole via the latch clevis pin.

550 is the latch handle.

600 is the joint.

610A is the first joint bracket.

610B is the second joint bracket.

620A is the first joint pivot rod.

620B is the second joint pivot rod.

700 is a lock nut.

710 are the internal threads of the lock nut.

720 is a torque nut.

721 is the drive portion of an embodiment of the torque nut.

722 is the tip of the torque nut.

725 points to the threads in the torque nut.

F₁ depicts the clamping force applied to the fittings being clamped.

τ₁ is the torque of the torque nut at the lower clamp clevis.

τ₂ is the torque of the lock nut at the torque nut.

This specification discloses a releasable clamp (100) comprising an upper clamp ring (200), a lower clamp ring (300), a shaft component (400), a latch (500), and a joint (600). The assembly may further comprise a torque nut (720) for adjusting the pressure i.e. the clamping force applied to the upper and lower clamp ring to hold the clamps together around the flanges of the fittings being clamped together.

As detailed below, this clamp assembly can be configured so that when closed around the articles being clamped together, the clamp has a “preset” consistent amount of torque or clamping force applied to the clamp rings to hold the items being clamped together. In this manner over torqueing or applying too much clamping force in the field is avoided.

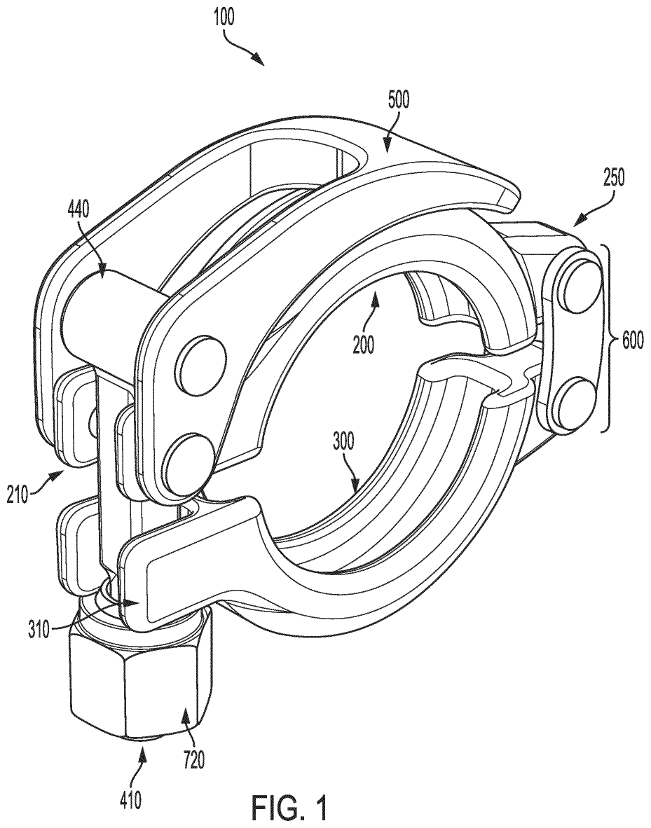

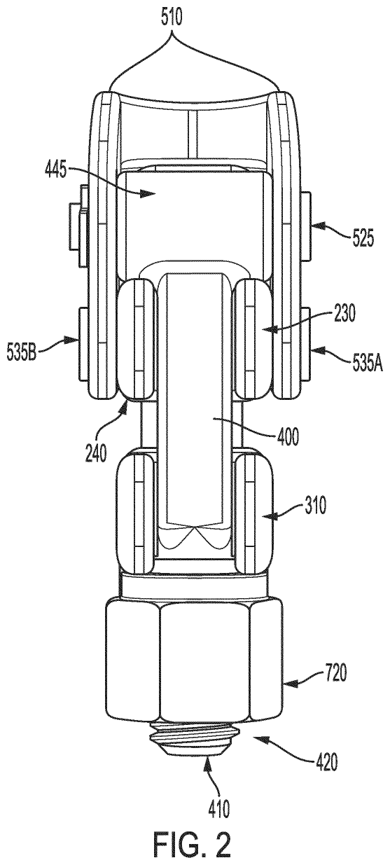

FIGS. 1 through 5 are an embodiment where the upper clamp ring has an upper clamp ring first end (210) and an upper clamp ring second end (250) opposite the upper clamp ring first end.

The upper clamp ring first end has an upper clamp ring clevis (220). The upper clamp ring clevis has a first prong (230) with the first prong having a first prong through-hole (235). The upper clamp ring clevis also has a second prong (240) with a second prong through-hole (245). There is a space between the first prong and the second prong of the upper clamp ring clevis. The upper clamp ring second end (250) may have an upper clamp ring through-hole (260).

The lower clamp ring (300) further comprises a lower clamp ring first end (310) and a lower clamp second end (350) with the lower clamp ring first end opposite the lower clamp ring second end.

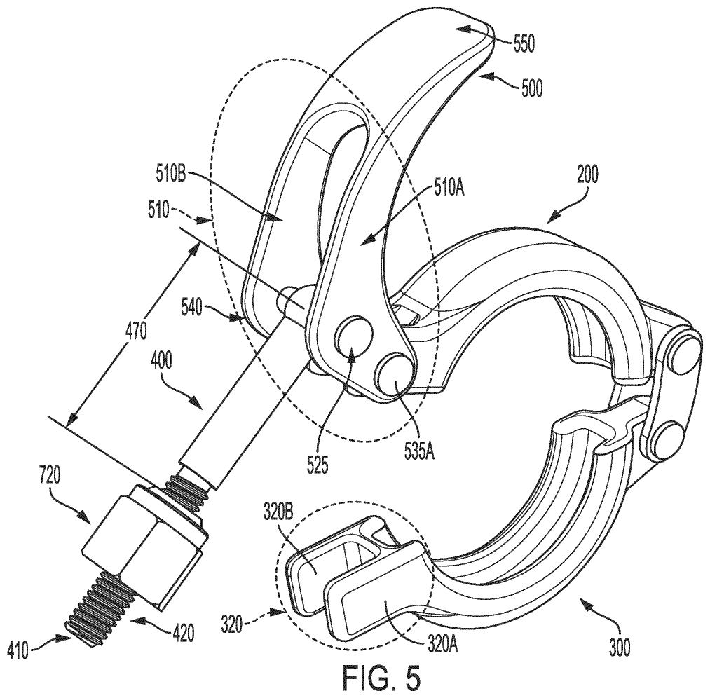

The lower clamp ring further comprises a lower clamp ring clevis (320) at the lower clamp ring first end. As depicted in FIG. 5, the lower clamp ring clevis first prong is shown as 320A and the lower clamp ring clevis second prong is 320B. The lower clamp ring may further comprise a lower clamp ring through-hole (360) at the lower clamp ring second end. The lower clamp ring clevis may or may not have holes through its prongs.

The lower clamp ring second end and upper clamp ring second end are pivotally engaged with each other. In one embodiment the lower clamp ring second end is directly attached to the upper clamp ring second end. Preferably the pivotal connection is done via a joint (600).

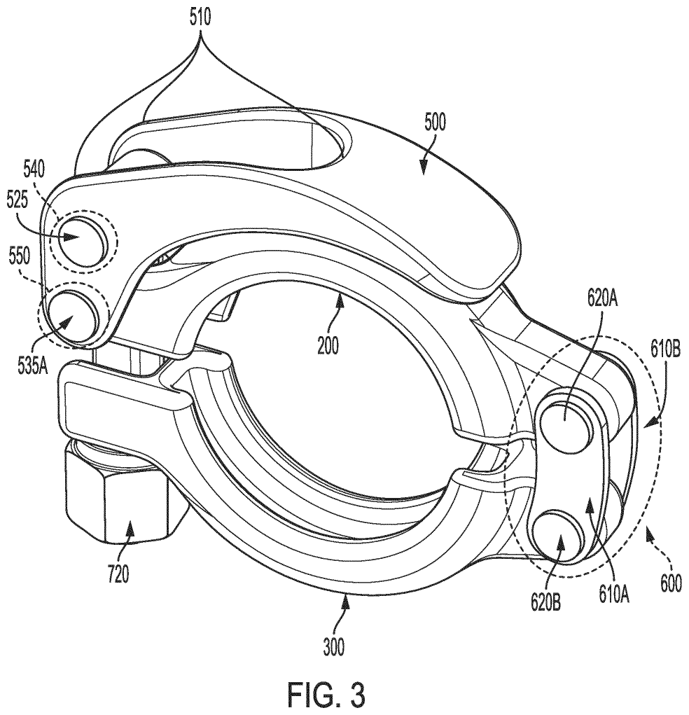

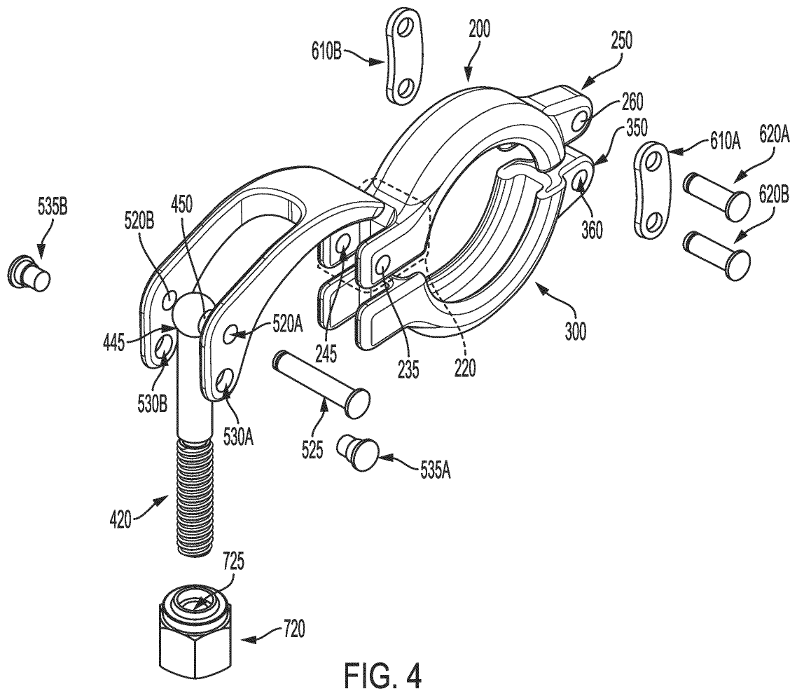

In one embodiment, the joint (600) is formed by a first joint bracket (610A) and a second joint bracket (610B). As shown in the figures (particularly FIGS. 3 and 4), this embodiment has the first joint bracket and second joint brackets pivotally attached at the upper clamp ring through-hole (260) with a first joint pivot rod (620A) passing through a hole on the first joint bracket, the upper ring clamp through-hole, and then a hole on the second joint bracket. The first joint bracket and second joint bracket are pivotally attached at the lower clamp ring through-hole (360) with the second joint pivot rod (620B) passing through a hole on the first joint bracket, the upper ring clamp through-hole, and then a hole in the second joint bracket.

The first and second joint pivot rods are preferably secured so the upper and lower clamp rings do not become separated. The joint pivot rods can be secured at the ends by engineering a head which is wider than the through-hole on one end of the pivot rod and threads on the other end. A nut on the threads can be used to then secure the pivot rod. Alternatively, a cotter pin through a hole in one or both ends of the joint pivot rod can also secure the engagement. In the embodiment shown in FIG. 4, each joint pivot rod has a large head one end and a groove for a clip on the other end.

In another embodiment, the second ends of the upper and lower clamp rings each have a clevis joint with a through-hole. In this embodiment, there is a single joint bracket between the prongs of each clevis with the first joint pivot rod passing through one prong of the upper clamp ring second end clevis joint, a through-hole in the joint plate and then through the other prong of the upper clamp ring second end clevis joint. Similarly, the second joint pivot rod would pass through one prong of the lower clamp ring second end clevis joint, a through-hole in the joint plate and then through the other prong of the lower clamp ring second end clevis joint.

If more strength is needed the space between the prongs on the second ends of the upper and lower clamp could be enlarged and the single joint bracket made thicker.

The shaft component (400) has a shaft component first end (410) and a shaft component second end (440). The shaft component second end is assembled between the two prongs of the upper clamp ring clevis and is pivotally engaged with the upper clamp ring clevis.

This may be done by providing a pivot area (445) at the shaft component second end. The pivot area has a hole (450) perpendicular to the shaft component. The pivot area is the portion of the shaft surrounding a hole through the shaft. The pivot area may include an enlarged ball such as shown in FIG. 4, or it may just be a cylinder as shown in FIG. 1, or there may be no difference in shape from the shaft body. While in one embodiment the shaft component has threads on one end, it may have a rectangular shaped portion, or a square shape portion along the area where the threads are absent.

It is preferable that the pivot area span the distance between the prongs of the latch clevis (510).

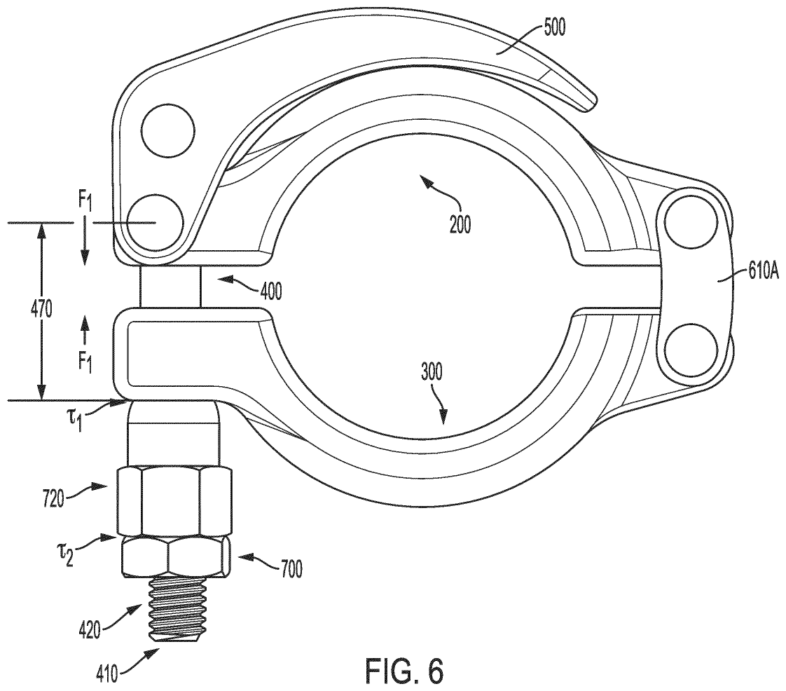

In one embodiment, the shaft component first end has external threads (420) matched to the internal threads of the torque nut (720). In this manner, the location of the torque nut along the shaft component first end determines the effective length of the shaft component (470) so that the clamp fits tight, applying the clamping force when the latch is pushed towards the upper clamp ring and engaged as shown in the Figures. If the torque nut is movable, the torque nut will have a torque nut torque as shown in FIG. 6. As explained below it is preferable that the torque nut be fixed and not movable, which in that case, the torque nut torque is 0 Nm.

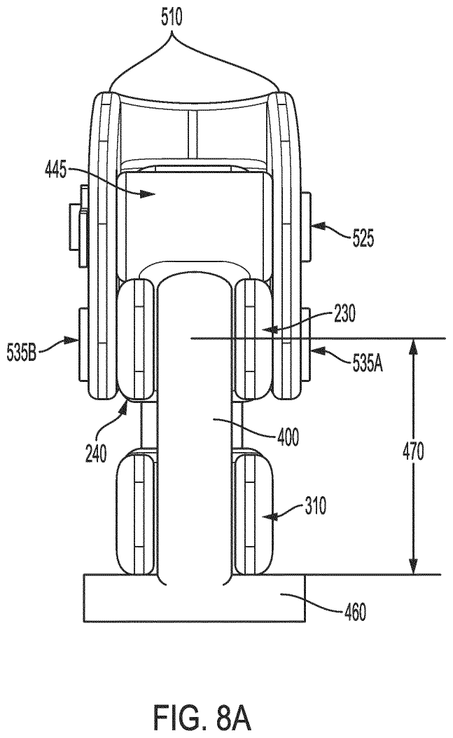

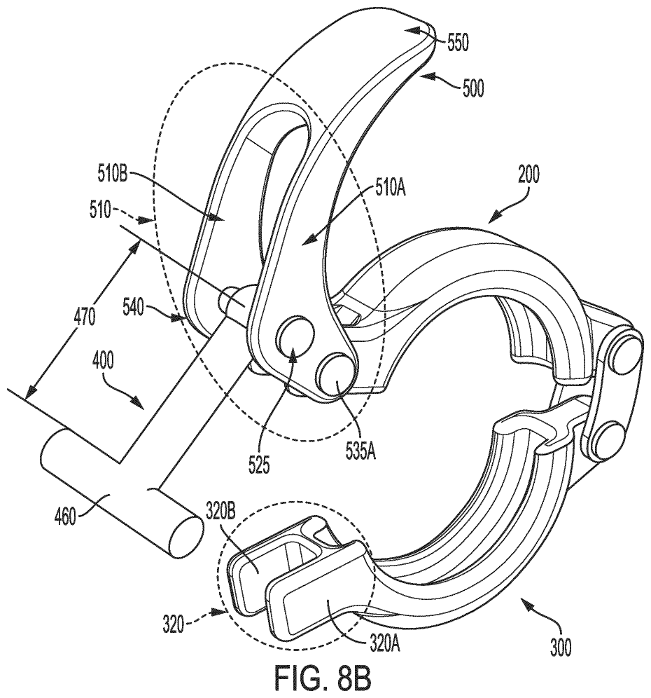

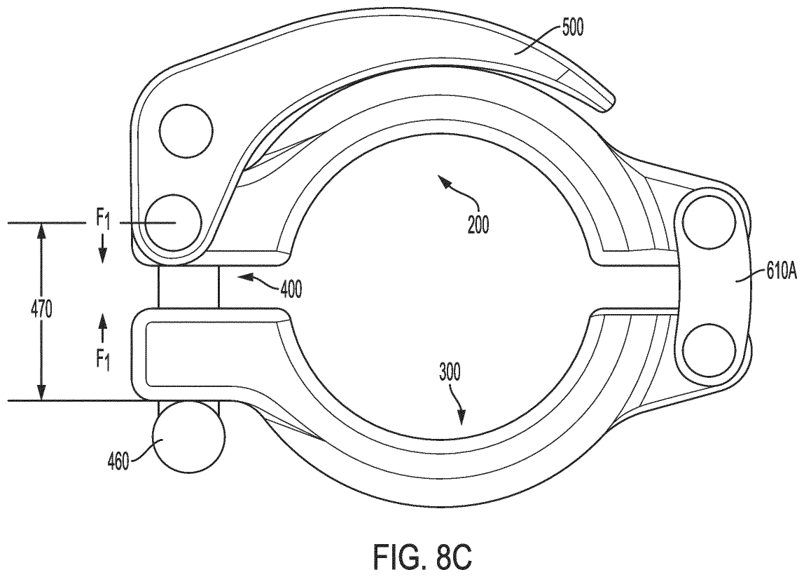

In one embodiment the shaft component first end is larger than the space between the prongs of the lower clamp ring clevis in at least one direction. As shown in FIGS. 8A, 8B, and 8C, one type of shaft component would be in the shape of a “T” at the end instead of threads and a torque nut. The perpendicular part of the “T” prevents the shaft from pulling through the lower clamp ring clevis as the latch is engaged. The shape of the shaft at the place where it is larger than the space between the prongs of the lower clamp ring clevis in at least one direction is not so important—it could be a ball or knob shaped, a “T”, or a larger cylinder for example.

The distance from the “T”, or area wider than the space between the lower clamp ring clevis prongs of the lower clamp ring clevis to the center of the hole in the pivot is the effective length of the shaft component that determines the clamp's pressure applied on the items being clamped when the latch is closed.

The latch first end has a latch clevis (510). The latch has a latch second end, or latch handle, opposite the latch first end. In operation, the latch second end (the latch handle) is pushed towards the upper clamp ring to engage the clamp assembly around the items being clamped.

The latch clevis prongs (510A and 510B) have an upper pivot through-hole (520A, 520B) and a lower pivot through-hole (530A, 530B). When assembled as shown in the embodiments in the Figures, the shaft component is pivotally attached to the latch clevis at the upper pivot through-hole (520A, 520B) via the latch clevis pin (525) which passes through the hole in the pivot area of the shaft component.

The latch clevis is pivotally engaged with the upper clamp ring. In the embodiment shown in the Figures, this engagement is at the upper clamp ring first prong, with the upper clamp ring first prong through-hole pivotally attached to the latch clevis via the first pivot button (535A) which passes through the first lower pivot through-holes (530A) and the upper clamp first prong through-hole. The upper clamp ring second prong through-hole is pivotally attached to the latch clevis via the second pivot button (535A) which passes through the second lower pivot through-hole (530B) and the upper clamp second prong through-hole.

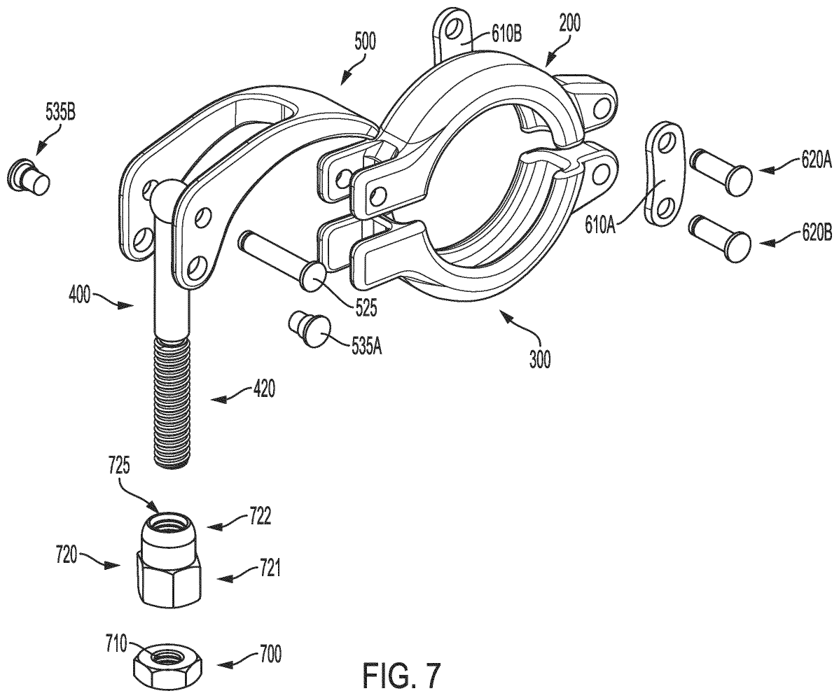

The embodiment in FIGS. 6 and 7 depicts how the clamp can have, and maintain, a pre-set torque/clamping force before the clamp is installed on the fittings. FIG. 6 shows two nuts. The first nut (720) is called the torque nut. As shown in FIG. 7, the torque nut has a drive portion (721), a tip (722) and internal threads (725).

The drive portion of the torque nut is used to rotate the torque nut around the shaft component to move the torque nut closer to or further away from the shaft component pivot hole. The torque nut tip (722) is set at a pre-determined distance from the shaft component pivot hole. As mentioned previously, this distance is the effective length of the shaft component. This pre-determined distance is the distance at which there will be the desired amount of clamping force when the clamp is installed around the fittings.

Preferably the torque nut is fixed and does not move about the shaft component. In one embodiment, the pre-determined distance (effective length) can be maintained by fixing the torque nut through the use of the lock nut (700). As shown in FIG. 6, the lock nut abuts the torque nut with a positive lock nut torque (τ₂) The amount of lock nut torque should be an amount sufficient to keep the torque nut from turning on its own during shipment or by hand. Preferably this is in the range of 2 Nm (17-inch LBS) to 5.7 Nm (50 inch LBS).

Another alternative to fixing the torque nut is to use a thread locker or thread locking fluid. Typically, these are thin, single-component adhesives, which are applied to the threads for fasteners such as screws and bolts to prevent loosening, leakage, and corrosion. The torque nut is considered fixed when it takes at least 0.5 Nm of torque to initially turn the torque nut on the shaft component. This is referred to as the break-free torque. Even more preferable is that at least 1.0 Nm of torque to turn the torque nut on the shaft component. A preferable range of required torque is 2 Nm (17-inch LBS) to 5.7 Nm (50 inch LBS). Another preferable range is 7 Nm to 50 Nm.

Once explained, it should be evident to one of ordinary skill that in order to clamp the fitting, the force applied to the clamp must be greater than 0 and can be applied by closing the clamp latch pulling the torque nut against the lower ring clevis. Or the torque nut can be tightened after closing the latch. In any event the amount of force applied to the clamp (the clamping force) is preferably the amount force that can be created when the value of τ₁ is greater than 0 Nm. Preferably the amount of clamping force created by the torque nut should be that which can be created when the torque nut torque (τ₁) at the lower clamp clevis is in the range of 2 Nm (17-inch LBS) to 5.7 Nm (50 inch LBS). The clamping force is typically in the range of 2 Nm to 5.7 Nm as well. A preferred range for the clamping force is in the range of 2 Nm to 5 Nm.

Other methods of fixing the torque nut are to make the torque nut with nylon threads that create resistance to turning the torque nut or placing holes through the torque nut and the shaft and inserting a pin through the holes, such as a cotter pin.

In a similar fashion, the embodiment where the shaft first end is larger than the space between the prongs of the lower clamp ring clevis, such as the “T” shaped shaft component, would always have a fixed pressure (i.e. clamping force) for a given set of fittings, as the distance between the larger area and the shaft component pivot hole is always the same. Thus, when the latch engages the clamp around the fittings, the clamp squeezes the fittings together at a constant pressure. However, in this embodiment the clamping force is not adjustable.

As can be seen in the above explanation and embodiments, by keeping the distance between torque nut and shaft component pivot hole constant, the assembly places a controlled amount of force upon the clamps keeping the clamping pressure on the pipe fittings controlled as well.

1. A releasable clamp assembly (100) comprising
an upper clamp ring (200),
a lower clamp ring (300),
a shaft component (400), and
a latch (500);
the upper clamp ring comprising
an upper clamp ring first end (210), an upper clamp ring second end (250), with the upper clamp ring first end having an upper clamp ring clevis (220) having an upper clamp ring first prong (230) with an upper clamp ring first prong through-hole (235) and an upper clamp ring second prong (240) with an upper clamp ring second prong through-hole (245);
the lower clamp ring (300) comprising
a lower clamp ring first end (310), a lower clamp ring second end (350), with the lower clamp ring first end having a lower clamp ring clevis (320) with the lower clamp ring clevis comprising a space between a lower clamp clevis first prong (320A) and a lower clamp clevis second prong (320B), with the lower clamp ring first end opposite the lower clamp ring second end;
the shaft component comprising
a shaft component first end (410), a shaft component second end (440) opposite the shaft component first end, and a pivot area (445) with a shaft component pivot hole (450) passing through the shaft component at the pivot area;
the latch comprising
a latch clevis (510);
wherein the shaft component is pivotally engaged with the latch clevis;
the upper clamp ring is pivotally engaged with the latch clevis;
the shaft component is configured to have an effective length; and
the upper clamp ring second end is pivotally engaged with the lower clamp ring second end.

2. The assembly of claim 1, wherein the upper clamp ring and the lower clamp ring are pivotally engaged via a joint (600).

3. The assembly of claim 2, wherein the joint is pivotally attached to an upper clamp ring through-hole (260) and pivotally attached to a lower clamp ring through-hole (360).

4. The assembly of claim 1, wherein the shaft component effective length configuration is created having the shaft component first end larger than the space between the lower clamp clevis first prong and the lower clamp clevis second prong.

5. The assembly of claim 4, wherein the shaft component first end is shaped as a “T”.

6. The assembly of claim 1, wherein the shaft component effective length configuration is created by having the shaft component threaded and mated with a torque nut having a torque nut tip.

7. The assembly of claim 6 wherein the torque nut is fixed and at least 0.5 Nm torque is required to rotate the torque nut about the shaft component.

8. The assembly of claim 6 wherein the torque nut is fixed and at least 1.0 Nm torque is required to rotate the torque nut about the shaft component.

9. The assembly of claim 6 wherein the torque nut is fixed and at least 2 Nm torque to is required rotate the torque nut about the shaft component.

10. The assembly of claim 6 wherein the torque nut is fixed and at least 2 Nm to 50 Nm torque is required to rotate the torque nut about the shaft component.

11. The assembly of claim 6, wherein the torque nut is fixed by a lock nut abutting the torque nut with a lock nut torque (τ₂) which is the torque of the lock nut at the torque nut and the lock nut torque is greater than 0 Nm.

12. The assembly of claim 11 wherein the lock nut torque is greater than 0.5 Nm.

13. The assembly of claim 11 wherein the lock nut torque is greater than 1.0 Nm.

14. The assembly of claim 11 wherein the lock nut torque is in the range of 2 Nm to 5 Nm.

15. The assembly of claim 11 wherein the lock nut torque is in the range of 2 Nm to 50 Nm.

16. The assembly of claim 6, wherein the torque nut is fixed by a thread locker.

17. The assembly of claim 1 wherein the assembly at the shaft component first end cannot pass through the space between the lower clamp clevis first prong and the lower clamp clevis second prong as the latch is engaged.
